(19) United States
(12) Patent Application Publication
(10) Pub. No.: US 2021/0386613 A1
(43) Pub. Date: Dec. 16, 2021

(54) THERAPEUTIC APPARATUS AND METHOD FOR EFFECTING AUTOMATED PARALLEL MOBILIZATION OF A MUSCLE OR TENDON

(71) Applicant: Sta Active, LLC, Edina, MN (US)

(72) Inventors: Timothy John Porth, Edina, MN (US); Nathan Paul Stier, Chanhassen, MN (US); Rusty Lynn Wallman, Hamel, MN (US); Darrin Mark Swagel, Minnetonka, MN (US); Karl Frederick Biewald, Minneapolis, MN (US)

(21) Appl. No.: 17/346,922

(22) Filed: Jun. 14, 2021

Related U.S. Application Data
(60) Provisional application No. 63/039,690, filed on Jun. 16, 2020.

(51) Int. Cl. A61H 7/00

(52) U.S. Cl. CPC A61H 7/004; A61H 2201/1215; A61H 2201/165; A61H 2201/1671

(57) ABSTRACT

A therapeutic apparatus and a method for providing parallel mobilization treatment of a muscle or a tendon in a limb utilizing the therapeutic apparatus.

The therapeutic apparatus includes a driven endless belt which travels along a path, with a plurality of contact elements projecting from and spaced along the machine direction of the endless belt. The apparatus can provide parallel mobilization treatment to a tender location by releasably securing the therapeutic apparatus to a limb overlaying the tender location, and activating the therapeutic apparatus to drive the contact elements along a path wherein the contact elements contact and effect parallel mobilization of a muscle or a tendon at the tender location as the contact elements travel along an interaction segment of the path.

### BACKGROUND

Tendonitis is a prevalent condition amongst those leading an active lifestyle. Tendonitis is an inflammation or irritation of a tendon resulting in pain and tenderness just outside a joint, often induced by repetitive forceful motion. Tendonitis can occur in any tendon, but is most commonly experienced around the shoulders, elbows, wrists, knees and heels. Some common names for tendonitis include tennis elbow, golfer's elbow, pitcher's shoulder, swimmer's shoulder and jumper's knee.

A common form or tendonitis is Achilles tendonitis, which is sometimes associated with Plantar fasciitis (which involves inflammation of a thick band of tissue that runs across the bottom of the foot). Plantar fasciitis isn't technically a form of tendonitis because the plantar fascia isn't a tendon, but the conditions and treatments can be very similar.

Additionally, if tendonitis persists for several months, a condition known as tendinosis can develop. This type of condition can involve degenerative changes in the tendon along with abnormal blood vessel growth

Most cases of tendonitis can be successfully treated with rest, physical therapy and medications to reduce pain. A common physical therapy treatment for tendonitis involves periodic instrument assisted mechanical scraping or rubbing of the affected area by a trained professional over several weeks or months. This technique is generally known as Instrument Assisted Soft Tissue Mobilization (IAS™). Two well-known IAS™ therapeutic methods are the Graston™ Technique and Gua sha.

Unfortunately, the time commitment and expense involved in completing the therapy often causes persons afflicted with tendonitis to prematurely discontinue the therapy as soon as the pain begins to subside, resulting in an increased risk of reinjury.

Accordingly, a need exists for a safe, affordable and easy-to-use mechanical muscle and tendon scraping or rubbing instrument which persons afflicted with tendonitis or a similar condition that responds favorably to mechanical muscle and tendon scraping or rubbing can use at home.

### SUMMARY OF THE INVENTION

A therapeutic apparatus and a method for providing parallel mobilization treatment of a muscle or a tendon in a limb utilizing the therapeutic apparatus.

The therapeutic apparatus includes a driven endless belt, a plurality of contact elements, and a housing. The driven endless belt has a machine direction, a cross direction and a transverse direction for movement along a path which includes an interaction segment. The contact elements are attached to, project transversely from, and are spaced along the machine direction of the endless belt. The housing encloses the endless belt with a machine direction slot through the housing through which the contact elements project as they travel along the interaction segment of the path.

The treatment method includes the steps of (i) identifying a tender location on a limb in need of parallel mobilization treatment, (ii) obtaining a therapeutic apparatus having a plurality of contact elements which travel in a first machine direction along a path which includes an interaction segment, (iii) releasably securing the therapeutic apparatus to the limb whereby the interaction segment overlays the tender location, and (iv) activating the therapeutic apparatus to drive the contact elements along the path in the first machine direction for a defined therapeutic duration during which the elements contact and effect parallel mobilization of a muscle or a tendon at the tender location.

### BRIEF DESCRIPTION OF THE DRAWINGS

FIG. 1 is a partial exploded view of one embodiment of the invention.

FIG. 2 is a top view of the invention depicted in FIG. 1.

FIG. 3 is a front view of the invention depicted in FIG. 1.

FIG. 4 is a rear view of the invention depicted in FIG. 1.

FIG. 5 is a right side view of the invention depicted in FIG. 1.

FIG. 6 is an exploded view of the drive unit assembly of the invention depicted in FIG. 1.

FIG. 7 is a rear view of the drive unit assembly depicted in FIG. 6.

FIG. 8 is a right side view of the drive unit assembly depicted in FIG. 6.

FIG. 9 is a perspective view of the belt depicted in FIG. 6.

FIG. 10 is a perspective view of the electrical assembly depicted in FIG. 1.

FIG. 11 is a front view of the electrical assembly depicted in FIG. 10.

FIG. 12 is a left side view of the electrical assembly depicted in FIG. 10.

FIG. 13 is a right side view of the electrical assembly depicted in FIG. 10.

FIG. 14 is a perspective view of the contact element depicted in FIG. 6.

FIG. 15 is a rear view of the contact element depicted in FIG. 14.

FIG. 16 is a top view of the contact element depicted in FIG. 14.

FIG. 17 is front view of the contact element depicted in FIG. 14.

FIG. 18 is a bottom view of the contact element depicted in FIG. 14.

FIG. 19 is a cross-sectional view of the contact element depicted in FIG. 14 taken along line AA.

FIGS. 20A-C depict securement the invention as depicted in FIG. 1 onto an arm of a person at a location suffering from tendonitis or a similar condition that responds favorably to mechanical parallel mobilization of the muscle or tendon.

### DETAILED DESCRIPTION OF THE INVENTION INCLUDING A PREFERRED EMBODIMENT

Nomenclature Table

| REF. NO. | NAME |
|---|---|
| 10 | Therapeutic Apparatus |
| 10a | Front End of Therapeutic Apparatus |
| 10b | Rear End of Therapeutic Apparatus |
| 10c | First Side of Therapeutic Apparatus |
| 10d | Second Side of Therapeutic Apparatus |
| 10e | Top of Therapeutic Apparatus |
| 10f | Bottom of Therapeutic Apparatus |
| 100 | Drive Unit Assembly |
| 110 | Endless Belt |
| 110m | Machine Direction of Endless Belt |
| 110m1 | First Machine Direction of Endless Belt |
| 110c | Cross Direction of Endless Belt |
| 110t | Transverse Direction of Endless Belt |
| 121 | Driven Head Pulley |
| 122 | Tail Pulley |
| 129 | Path of Travel |
| 129s | Interaction Segment of Path of Travel |
| 130 | Contact Element |
| 130d | Distal End of Contact Element |
| 130t | Height of Contact Element |
| 130α | Angle of Projection of Contact Element |
| 140 | Motor |
| 150 | Belt Enclosure |
| 160 | Battery |
| 200 | Control System |
| 210 | Microcontroller |
| 220 | User Interface Panel |
| 230 | Display |
| 300 | Housing |
| 300a | Front End of Housing |
| 300b | Rear End of Housing |
| 300c | First Side of Housing |
| 300d | Second Side of Housing |
| 300e | Top of Housing |
| 300f | Bottom of Housing |
| 301 | Bottom Tray of Housing |
| 302 | Top Cover of Housing |
| 309 | Machine Direction Slot Through Bottom of Housing |
| 310 | Band or Strap |
| A | Human Ann |
| Ax | Length of Arm |

### Construction

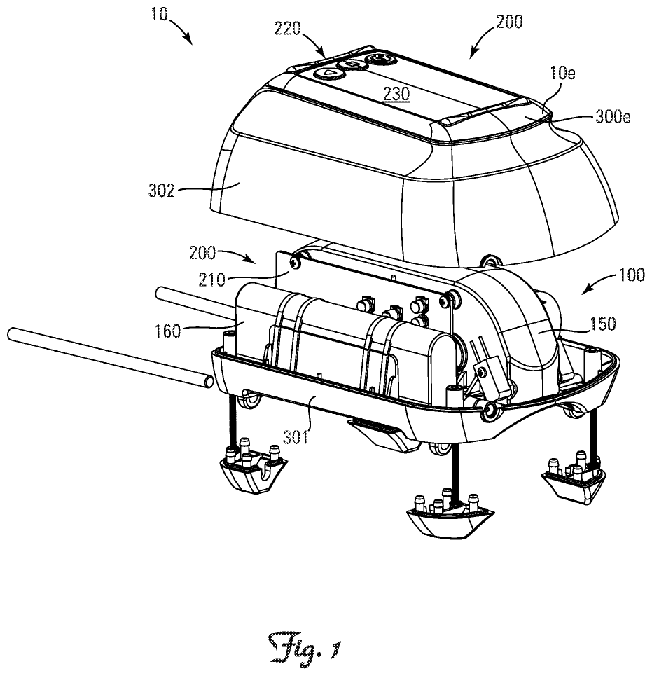

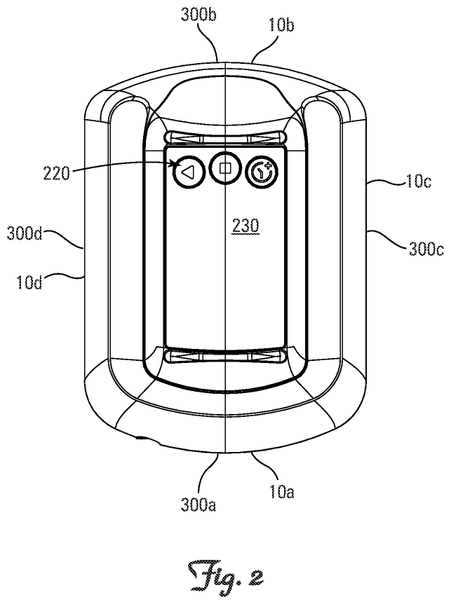

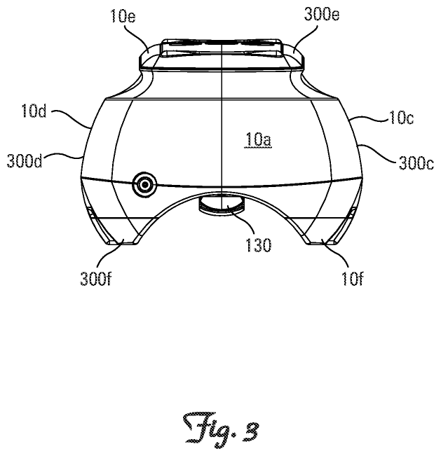

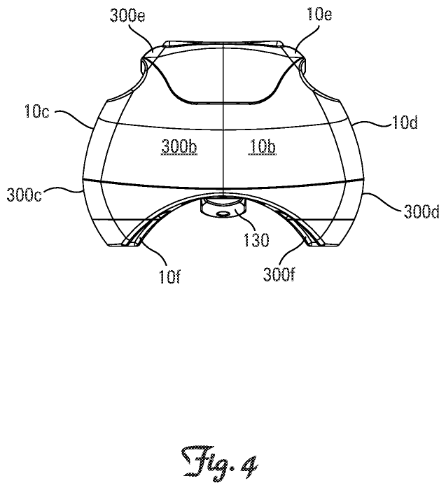

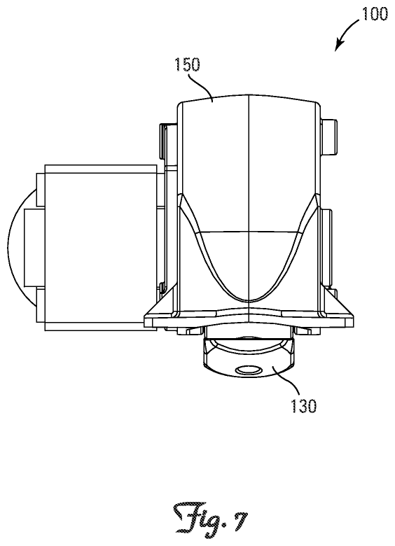

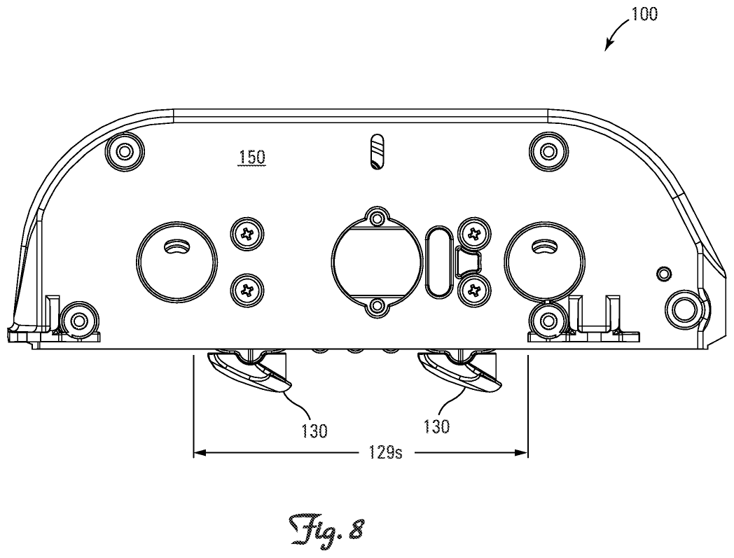

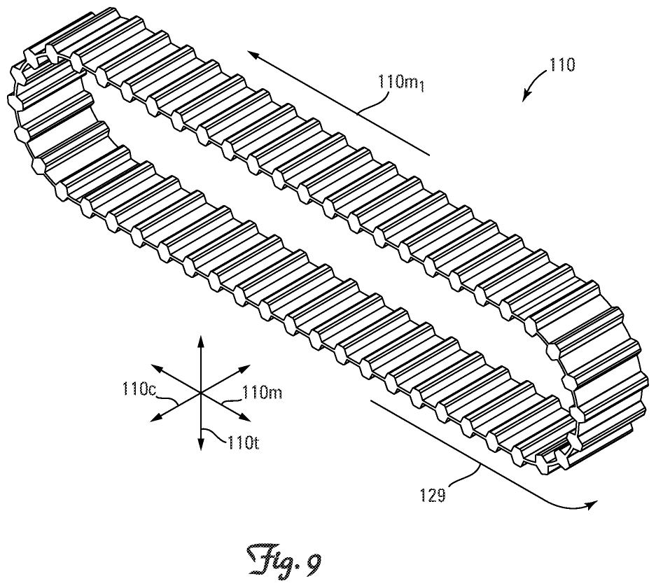

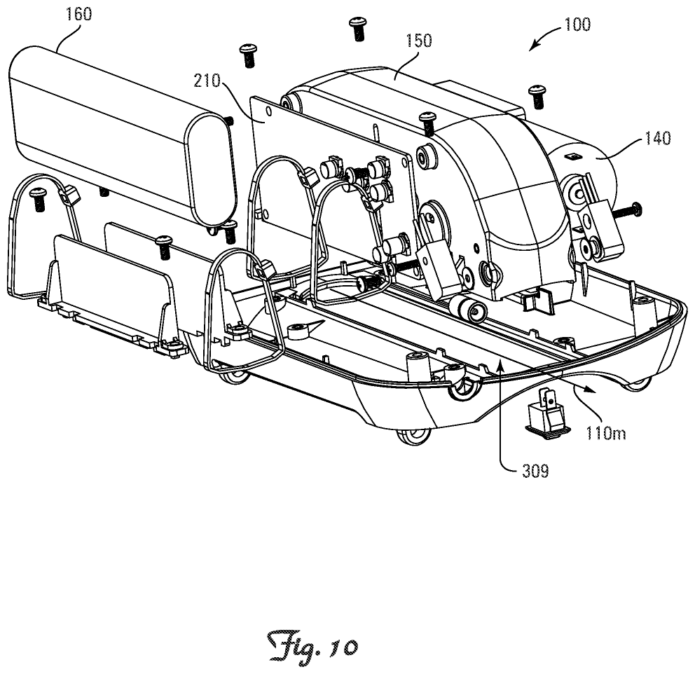

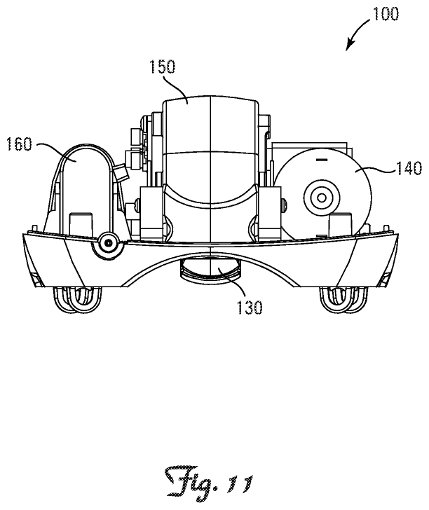

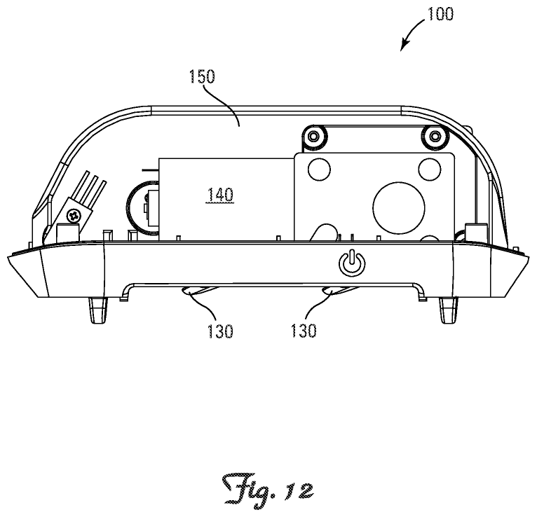

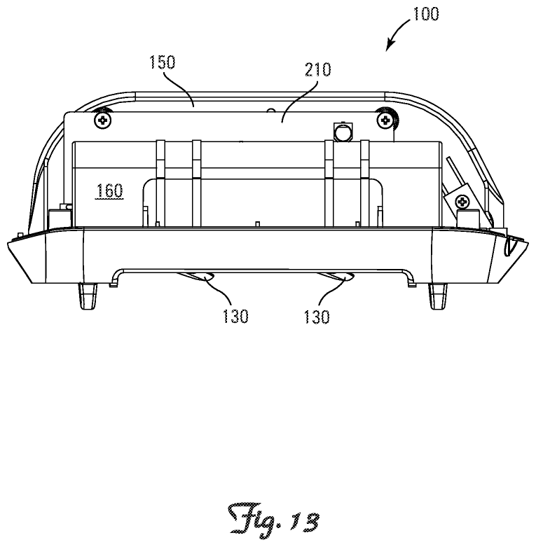

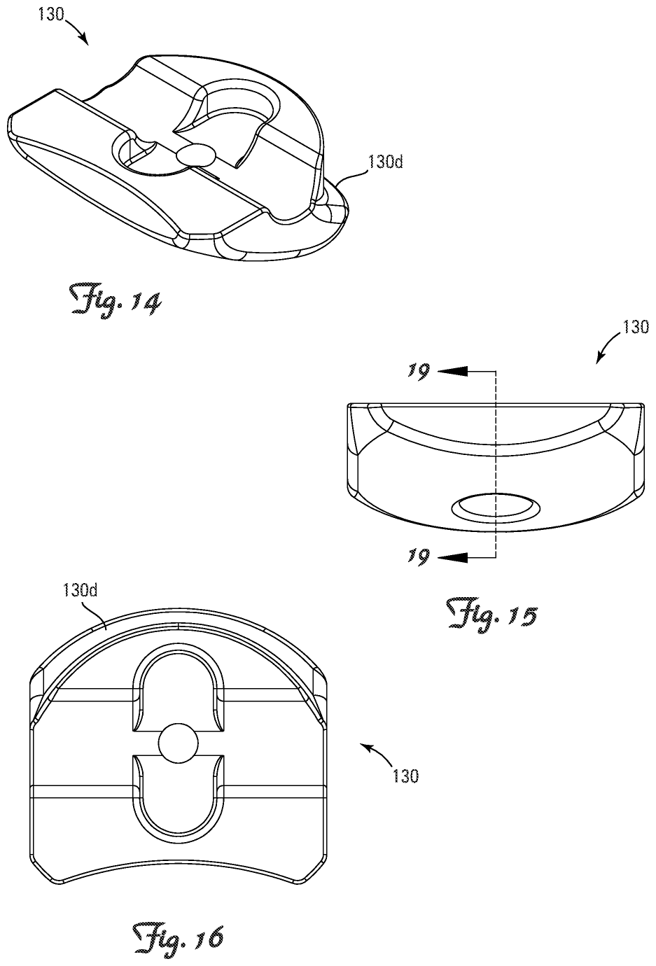

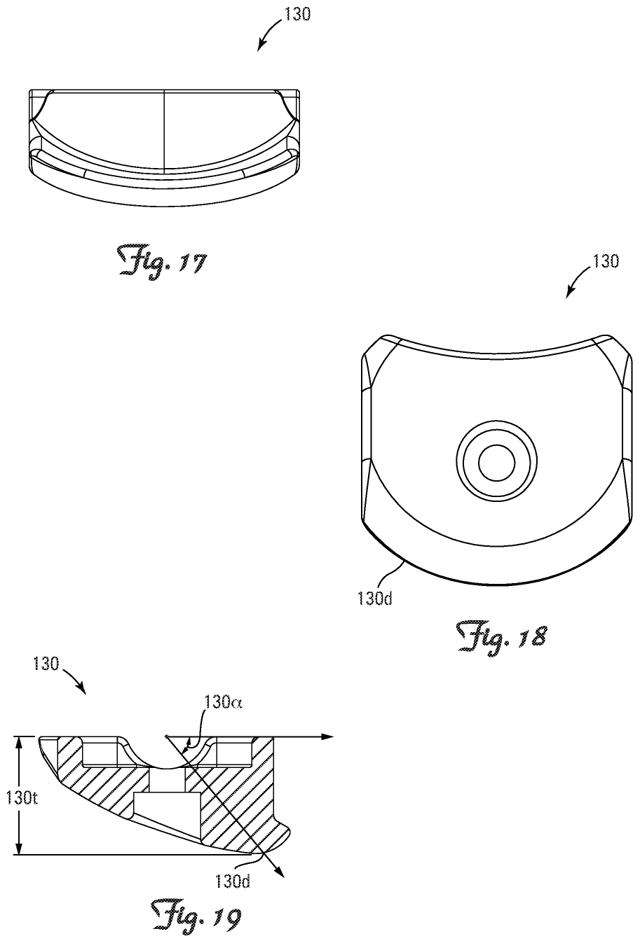

Referring to FIGS. 1-19, the therapeutic apparatus 10 is a safe, affordable and easy-to-use mechanical muscle and tendon scraping/rubbing instrument suitable for at-home treatment of tendonitis or a similar condition that responds favorably to mechanical parallel mobilization of the muscle or tendon, such as tendinosis, plantar fasciitis, etc. The apparatus 10 can provide therapeutic unidirectional scraping of an area underneath the instrument for a user input duration.

Referring to FIG. 1, the therapeutic apparatus 10 includes a drive unit assembly 100 and a power source 160 retained within a housing 300. The therapeutic apparatus 10 preferably also includes a control system 200 that includes at least a microcontroller 210, a user interface panel 220 and a display 230 for allowing user control of the drive unit assembly 100. The interface panel 220 and display 230 can be provided onboard, or can be provided on or through a remote device such as via a remote control or an application on a smartphone or tablet.

Referring to FIGS. 1-5, the apparatus 10 has a front end 10a, a rear end 10b, first and second sides 10c and 10d, a top 10e and a bottom 10f.

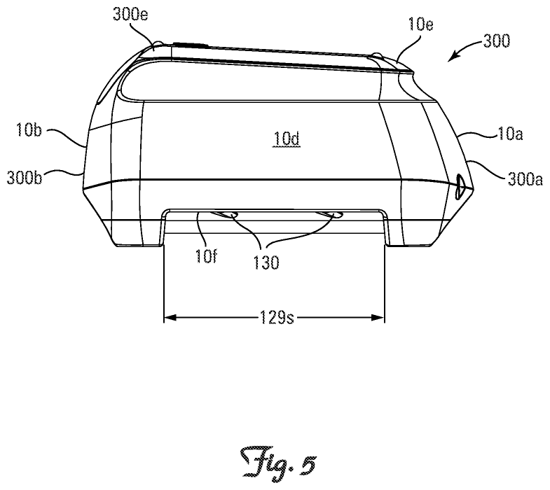

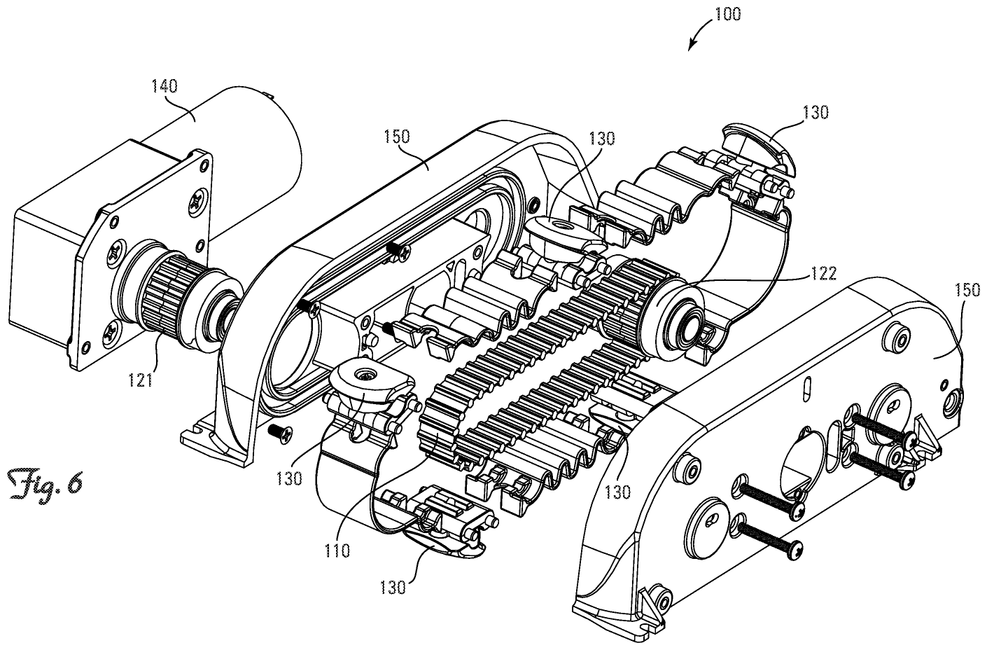

Referring to FIGS. 6-8, the drive unit assembly 100 includes an endless belt 110, a plurality of contact elements 130 projecting in a transverse direction 110t from the endless belt 110, and a motor 140 powered by the power source 160 for driving the endless belt 110 in a first machine direction 110m₁ along a path 129.

Referring to FIG. 6, the endless belt 110 is entrained around a head pulley 121 and a tail pulley 122. The head pulley 121 is driven by the motor 140. The endless belt 110 can have a length in the machine direction 110m of about 8 to 20 inches and provide an interaction segment 129s of about 2 to 10 inches. A length of less than about 8 inches provides an interaction segment 129s which is too short to be effective in many situations, while a length of greater than about 20 inches results in an unwieldly apparatus 10 with an interaction segment 129s far longer than necessary to effectively treat a muscle or tendon.

A single wheel (not shown) could be employed as an alternative to the endless belt 110, but is not preferred as the contact elements 130 would travel along an arc rather than a straight line through the interaction segment 129s of the path 129.

The motor 140 drives the endless belt 110 in the first machine direction 110m₁ along the path 129 at a defined speed. A suitable range for speed of travel is between 1 and 10 ft/min. A speed of travel slower than about 1 ft/min unnecessarily prolongs each treatment while a speed of travel faster than about 10 ft/min can irritate the skin and reduce effectiveness of the treatment as it diminishes the time period between scrapings during which the muscle or tendon recovers from the previous scrape.

Referring to FIGS. 6-8, the contact elements 130 are attached to and spaced, preferably uniformly spaced, along the machine direction 110m of the endless belt 110. One suitable spacing of the contact elements 130 is between 1 and 5 inches from one-another, measured distal tip 130d to distal tip 130d. Referring to FIG. 14-19, the contact elements 130 extend a width in the cross direction 110c and project a height 130t in the transverse direction 110t from the endless belt 110. One suitable range of heights 130t of the contact elements 130 is between 0.2 to 1 inch from the endless belt 110. A height 130t of less than about 0.2 inches forces positioning of the endless belt in close proximity to the skin during use of the apparatus 10 so as to pose a high risk that the endless belt 110 will catch or pinching the skin, while a height 130t of greater than about 1 inch results in an unnecessarily large and unwieldy apparatus 10 and due to increased leverage between the endless belt 110 and the distal tip 130d of each contact element 130 can result in an undesired rocking of the contact elements 130 in the machine direction 110m during use.

Referring to FIG. 14-19, the contact elements 130 each have a distal tip or end 130d. The distal tip 130d of each contact element 130 preferably projects at an acute angle 130a in the first machine direction 110m₁ from the contact elements 130, measured from the center of the surface area of the contact elements 130 facing the endless belt 110 to the distal most tip 130d of the contact elements 130. One suitable range of acute angles 130a is 20° to 40°.

The contact elements 130 can be releasably attached to the endless belt 110 for allowing replacement of worn or damaged contact elements 130 and replacement of the contact elements 130 with ones of different size, shape, hardness, etc.

Referring to FIGS. 6-8 and 10-13, the endless belt 110 and pulleys 121 and 122 can be enclosed within a belt enclosure 150 for separating the moving components of the drive unit assembly 100 from other components of the apparatus 10.

Referring to FIGS. 1-5 and 10-13, the drive unit assembly 100 and power source 160, along with any other optional components, can be retained within a housing 300. The housing 300, in coordination with the spatial orientation of the apparatus 10, has a front end 300a, a rear end 300b, first and second sides 300c and 300d, a top 300e and a bottom 300f. In a preferred embodiment the housing 300 is split between a bottom tray 301 and a top cover 302.

A slot 309 extending in the machine direction 110m from the front 300a to the back 300b of the housing 300 extends through the bottom 300f of the housing 300. The slot 309 is positioned and sized for allowing the contact elements 130 to project out from the interior of the housing 300 and unidirectionally rub against the surface of an appendage A to which the apparatus 10 is strapped as the endless belt 110 travels along the path 129. Referring to FIG. 12, that portion of the path 129 traveled by the endless belt 110 where the contact elements 130 project out from the interior of the housing 300 through the slot 309 for contact with an appendage A is designated as the interaction segment 129s of the path 129.

The spacing of the contact elements 130 and the length of the interaction segment 129s are preferably selected so that at least two contact elements 130 extend through the slot 309 in the housing 300 at all times as the endless belt 110 is driven in the machine direction 110m along the path 129. This helps limit front-to-back rocking of the apparatus 10 during use.

The bottom 300f of the housing 300 should be curved to conform to a human limb A with the slot 309 through the housing 300 extending along the longitudinal length Ax of the limb A for allowing the contact elements 130 to contact and effect parallel mobilization of a muscle or a tendon in the limb A as the contact elements 130 travel in the machine direction 110m along the interaction segment 129s of the path 129.

A band or strap 310 may be provided for temporarily securing the apparatus 10 to a human limb A with the slot 129s through the bottom 300f of the housing 300 extending along a longitudinal axis Ax of the limb A for allowing the contact elements 130 to contact a surface of the limb A and effect parallel mobilization of a muscle or a tendon under the contacted surface as the contact elements 130 travel along the interaction segment 129s of the path 129. The band or strap 310 may be elastic, inelastic or segmented with lengths of each.

The apparatus 10 may optionally include a heating unit for providing heat treatment to the area, and/or a vibration unit for providing vibrational treatment of the area along with the scraping parallel mobilization therapy.

The optional but preferred control system 200 is operable for controlling at least one operational parameter of the apparatus 10, allowing user input to establish the value of the at least one operational parameter, and display operational settings and/or performance values. The operational parameter may be one or more of travel speed of the endless belt 110, interval changes in travel speed, duration of travel of the endless belt 110 in the first machine direction 110m₁ along the path 129, pauses in endless belt 110 rotation, etc.

The control system 200 can be programmed with an emergency stop whenever a voltage spike is observed, indicative of something caught in the endless belt 110.

### Use

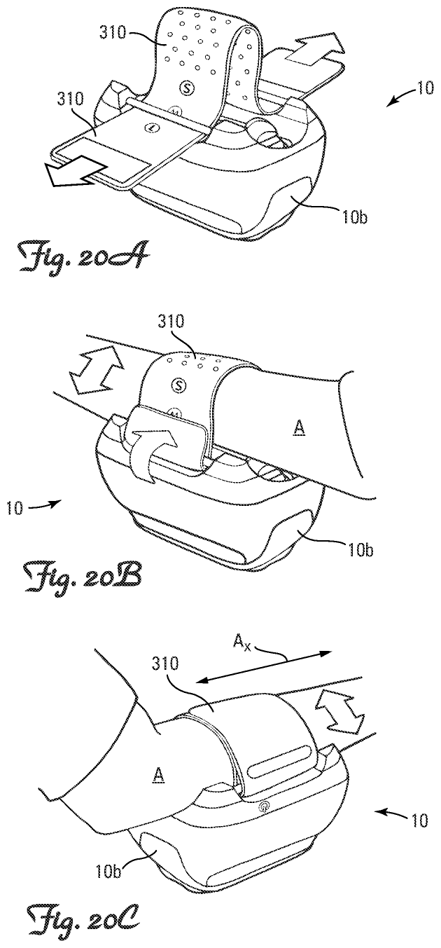

Referring to FIG. 20A-C, mechanical parallel mobilization treatment of a muscle or a tendon in a limb A may be achieved by (i) identifying a tender location on a limb A in need of parallel mobilization treatment, (ii) obtaining a therapeutic apparatus 10 having a plurality of contact elements 130 which travel in a first machine direction 110m along a path 129 which includes an interaction segment 129s, (iii) strapping the therapeutic apparatus 10 to the limb A whereby the interaction segment 129s overlays the tender location, and (iv) activating the therapeutic apparatus 10 to drive the contact elements 130 along the path 129 in the first machine direction 110m₁ for a defined therapeutic duration during which the contact elements 130 contact and effect parallel mobilization of a muscle or a tendon underlying the tender location.

Each therapeutic event as set forth can have a duration between about 2 and 30 minutes. Shorter durations tend to be less effective while longer durations provide diminishing returns at the risk of creating friction burn, skin abrasions, bruising, or otherwise injuring the skin. The treatment events are preferably periodically repeated throughout a treatment period. An exemplary treatment regimen is a therapeutic event frequency between once and four times every two days over a treatment period of at least seven days.

Referring to FIG. 20A-C, the therapeutic apparatus 10 can be secured to an appendage A over an area afflicted with tendonitis or a similar condition that responds favorably to mechanical muscle and tendon scraping parallel mobilization with an elastic strap 310. The scraping force exerted by the contact elements 130 against the soft tissue underneath the apparatus 10 is primarily dictated by the compression strength of the strap 310, which in turn is dictated by how tightly the strap 310 is wrapped around the appendage A. As depicted in FIGS. 20A and 20B, longitudinally spaced markings (denoted S, M, L in FIGS. 20A and 20B) may be provided along the length of the strap 310 to assist with proper adjustment of the strap 210 size to fit various size appendages A. Additional longitudinally spaced markings may be provided along the length of the strap 310 so that once a comfortable compression setting is found the strap 310 may be easily wrapped to the same compression in subsequent sessions.

An emollient can optionally be applied to the area to be scrapped just prior to use of the apparatus 10 to minimize surface friction.

One suitable treatment plan using the apparatus 10 is an eight-week treatment that combines consistent use of the apparatus 10 along with consistent stretching and strengthening exercises.

It is generally preferred to first rub an emollient on the area of the appendage A that will be treated. The instrument 10 is then placed onto the appendage A over the treatment area. The instrument 10 is preferably oriented, when possible, so that messages on the display screen 230 can be read while the instrument 10 is activated. Once the instrument 10 is activated, it may be repositioned slightly to find the injured area. The specific area treated by the instrument 10 may be adjusted for each session as desired. Markings may be provided on the exterior of the housing 300 to indicate the longitudinal start and stop points of scraping by the contact elements 130 for facilitating initial placement and subsequent adjustment of the instrument 10 on the appendage A.

I claim:

1. A therapeutic apparatus, comprising:
(a) a driven endless belt having a machine direction, a cross direction and a transverse direction for movement along a path which includes an interaction segment,
(b) a plurality of elements attached to, transversely projecting from and spaced along the machine direction of the endless belt,
(c) a housing enclosing the endless belt with a machine direction slot through the housing through which the elements project as they travel along the interaction segment of the path.

2. The therapeutic apparatus of claim 1 further comprising a band for temporarily securing the apparatus to a human limb with the slot longitudinally extending along the limb for allowing the elements to contact a surface of the limb and effect parallel mobilization of a muscle or a tendon under the contacted surface as the elements travel along the interaction segment of the path.

3. The therapeutic apparatus of claim 1 further comprising a motor for driving the endless belt in a first machine direction at a speed of less than 10 ft/min and a microcontroller for controlling at least one operational parameter selected from travel speed and duration of travel of the endless belt in the first machine direction along the path.

4. The therapeutic apparatus of claim 3 further comprising an onboard battery, an onboard user interface for setting the value of the at least one operational parameter, and an onboard display for displaying the set value of the at least one operational parameter.

5. The therapeutic apparatus of claim 1 wherein the endless belt has a machine direction length of about 8 to 20 inches.

6. The therapeutic apparatus of claim 1 wherein the interaction segment has a machine direction length of about 2 to 10 inches.

7. The therapeutic apparatus of claim 1 wherein the elements are uniformly spaced along the machine direction of the endless belt.

8. The therapeutic apparatus of claim 1 wherein the elements, measured distal tip to distal tip of the elements, are spaced between 1 and 5 inches from one-another along the machine direction of the endless belt.

9. The therapeutic apparatus of claim 1 wherein the elements are spaced such that at least two elements extend through the slot in the housing at all times as the endless belt is driven along the path.

10. The therapeutic apparatus of claim 1 wherein the elements each (i) extend a distance of about 0.2 to 1 inch from the endless belt, (ii) project at an acute angle in a first machine direction from the endless belt, and (iii) have a distal end arched in the cross-direction.

11. The therapeutic apparatus of claim 10 wherein the endless belt travels in a first machine direction and the elements project at an angle of 20° to 40° in the first machine direction from the endless belt.

12. The therapeutic apparatus of claim 1 wherein (i) the housing has a bottom, (ii) the slot extends through the bottom of the housing, (ii) the bottom of the housing is curved to conform to a human limb with the slot extending along the length of the limb for allowing the elements to contact and effect parallel mobilization of a muscle or a tendon in the limb as the elements travel in the machine direction along the interaction segment of the path.

13. A method for providing parallel mobilization treatment of a muscle or a tendon in a limb, comprising:
(a) identifying a tender location on a limb in need of parallel mobilization treatment,
(b) obtaining a therapeutic apparatus having a plurality of elements which travel in a first machine direction along a path which includes an interaction segment,
(c) releasably securing the therapeutic apparatus to the limb whereby the interaction segment overlays the tender location, and
(d) activating the therapeutic apparatus to drive the elements along the path in the first machine direction for a defined therapeutic duration during which the elements contact and effect parallel mobilization of a muscle or a tendon at the tender location.

14. The method of claim 13 further comprising periodically repeating steps (a)-(d) throughout a treatment period.

15. The method of claim 13 wherein the elements travel in the first machine direction at a speed of less than 10 ft/min.

16. The method of claim 13 wherein the therapeutic duration is between 2 and 30 minutes.

17. The method of claim 14 wherein treatment frequency is between once and four times every two days and the treatment period is at least seven days.

18. The method of claim 13 wherein the tender location suffers tendonitis.
